(19) United States
(12) Patent Application Publication
(10) Pub. No.: US 2019/0155233 A1
(43) Pub. Date: May 23, 2019

(54) System For Implementing A Technical Process On A Domestic Appliance

(71) Applicant: BSH HAUSGERAETE GMBH, MUENCHEN (DE)

(72) Inventors: MARKUS PFEIFFERER, LAPPERSDORF (DE); CHRISTIAN SEIBERT, TUERKENFELD (DE)

(21) Appl. No.: 16/300,087

(22) PCT Filed: May 5, 2017
(86) PCT No.: PCT/EP2017/060818

§ 371 Date: Nov. 9, 2018

(30) Foreign Application Priority Data
May 17, 2016 (DE) 10 2016 208 382.1

(51) Int. Cl. G05B 15/02; G06F 8/34

(52) U.S. Cl. CPC G05B 15/02; G05B 2219/2613; G06F 8/34

(57) ABSTRACT

A system for implementing a technical process on a domestic appliance includes a graphic editor, which allows the technical process to be described using graphical elements in order to create a graphical representation of the technical process. A translator unit, converts the individual graphic elements into instructions in a metalanguage to create a metalanguage file which describes the technical process in the metalanguage. The metalanguage is able to describe technical processes of many types of domestic appliances. An interpreter in a hardware module of the domestic appliance converts the instructions of the metalanguage file into software code, specific to the type of domestic appliance, for executing the technical process on the domestic appliance. The interpreter depends on the type of domestic appliance among the many types of domestic appliances.

The invention relates to a system for implementing a technical process on a household appliance, in particular on a home appliance. Furthermore, the invention relates to a household appliance having a technical process provided by the system.

The technical processes of household appliances are becoming ever more complex. For example, individual household appliances may have several dozen sensors and actuators and tens of thousands of operative parameters or process parameters. As the complexity increases, so does the need for systems that enable a process developer lacking knowledge of software development to create, and where necessary modify, programs for controlling a household appliance. Where possible in this context, systems that enable a developer to describe technical processes for different types of household appliance simply and intuitively are to be provided. The functionality of the technical processes described in this way is then to be checked by the system, autonomously and reliably, and converted into code (in particular to software code or a code with embedded commands for a processor) that can be executed by one or more processors of a household appliance in order to run a particular technical process on a household appliance (e.g. a particular brewing process, a particular laundry process, etc.).

The present document relates to the technical object of providing a system that enables a developer to describe technical processes of a household appliance intuitively and reliably and, based thereon, to provide code for controlling the household appliance.

The object is achieved by the subject matter of the independent claims. Advantageous embodiments are in particular defined in the dependent claims, described in the description below or illustrated in the accompanying drawings.

According to one aspect of the invention, a system for implementing a technical process on a household appliance, in particular a home appliance, is described.

The household appliance may be one household appliance type of a plurality of different types, where the plurality of types of household appliance includes for example washing machines, tumble dryers, automatic coffee makers, dishwashers, ovens and/or refrigerators. Examples of a technical process are a washing program for a washing machine, or a brewing program for an automatic coffee maker. A household appliance is typically intended for one or more tasks, or provided for one or more tasks (e.g. a coffee machine is for brewing a coffee, a washing machine is for washing laundry, etc.). A technical process of a household appliance may describe a process by which a task of the household appliance is performed. In particular, a technical process may go beyond providing a user interface for the household appliance. Rather, a technical process may describe how one or more process parameters (which are where appropriate determined by way of a user interface) are utilized for the purpose of fulfilling a task of the household appliance.

The system includes a graphic editor that makes it possible to describe the technical process using graphic elements, in order to create a graphical representation of the technical process. The graphic editor can be provided on an external computer (outside the household appliance). In particular, graphic elements predefined using the graphic editor may be concatenated in order to create the graphical representation of the technical process. Here it is where appropriate also possible to define part processes and sub-processes that can for their part be used in defining higher-level processes. Furthermore, process parameters can be established for the individual predefined graphic elements in order to define the technical process.

Further, the system includes a translator unit (e.g. on an external computer) that is intended to convert the individual graphic elements of the graphical representation of the technical process into the instructions of a metalanguage in order to generate a metalanguage file that describes the technical process in the metalanguage. Here, for each graphic element a quantity of instructions in the metalanguage may be stored. The instructions may be concretized using the process parameters established in the graphical representation, in order to describe the metalanguage file for the technical process.

Further, the system includes an interpreter that is intended to convert the instructions of the metalanguage file (in particular during operation of the household appliance) into code that is specific to the household appliance type, for the purpose of executing the technical process on the household appliance. The interpreter may be provided on the household appliance. The instructions in the metalanguage file may be converted into code that is specific to the household appliance type in real time, during operation of the household appliance.

In this way, the system is able to generate code for the technical process of a household appliance efficiently. Here, the interpreter can provide an abstraction of the technical properties of the different types of household appliance such that a single metalanguage can be used to generate code, intuitively and reliably, for different types of household appliance. In particular, the metalanguage may be structured such that technical processes of a plurality of types of household appliance can be described using the metalanguage. Thus, the metalanguage may be independent of a type of household appliance. On the other hand, the interpreter may be dependent on one type of household appliance of the plurality of types of household appliance and thus convert the instructions of the metalanguage that are not type-dependent into type-specific code for controlling a particular type of household appliance.

The system may include a checking unit (e.g. on an external computer) that is intended to check whether the graphical representation of the technical process can be carried out in the household appliance. Here, the checking unit may include an expert system based on artificial intelligence. This can ensure that even a user of the system who has no specific knowledge of the technical properties of a household appliance can efficiently generate an executable technical process for the household appliance.

Typically, the metalanguage includes a plurality of different instructions, for example: instructions that enable access to the sensors of the household appliance; instructions that enable control of the actuators of the household appliance; instructions that enable a delay to process steps of the technical process; instructions that enable conditional execution of process steps of the technical process; instructions that enable access to the input units of the household appliance; and/or instructions that enable control of the output unit of the household appliance. By providing a comprehensive set of abstract instructions, it is possible to generate complex technical processes for different types of household appliance simply.

The interpreter can include an expert system based on artificial intelligence. In particular, the interpreter may use expert knowledge to convert abstract instructions of a metalanguage into code that is specific to a type of household appliance.

The household appliance may contain a plurality of hardware modules each having one or more processors. The hardware modules may each include an interpreter for the purpose of executing at least some of the instructions of the metalanguage file. As a result of interactive execution of the instructions of a metalanguage file on different hardware modules of a household appliance, the operational reliability of the household appliance can be enhanced.

According to a further aspect, a household appliance having at least one hardware module is described. The hardware module includes an interpreter that is intended to convert instructions of a metalanguage file for the purpose of executing a technical process on the household appliance. Here, the instructions of the metalanguage file are derived from a metalanguage that is structured such that technical processes of a plurality of types of household appliance can be described using the metalanguage. By using an abstract metalanguage of this kind for controlling a household appliance, the costs of providing technical processes on a household appliance can be reduced. Furthermore, a flexible provision and adaptation of technical processes is enabled. In this context, the metalanguage may preferably be structured such that technical processes of a plurality of different types of household appliance can be described using the metalanguage. Furthermore, the interpreter may be dependent on one type of household appliance of the plurality of types of household appliance.

The household appliance may include a plurality of hardware modules each having one or more processors. Here, the plurality of hardware modules can exchange data with one another over a data bus. The hardware modules may each include an interpreter in order to execute at least some of the instructions of the metalanguage file. In this case, the household appliance may be intended to distribute the carrying out of the instructions of the metalanguage file over the interpreters of the plurality of hardware modules. In this way, the operational reliability of the household appliance can be efficiently enhanced.

According to a further aspect, a method corresponding to the above-mentioned system is described.

It should be noted that any of the aspects of the systems, methods and household appliances that are described in this document may be combined with one another in multiple ways. In particular, the features of the claims may be combined with one another in multiple ways.

The invention will be described in more detail below with reference to exemplary embodiments illustrated in the accompany drawings. In the drawings:

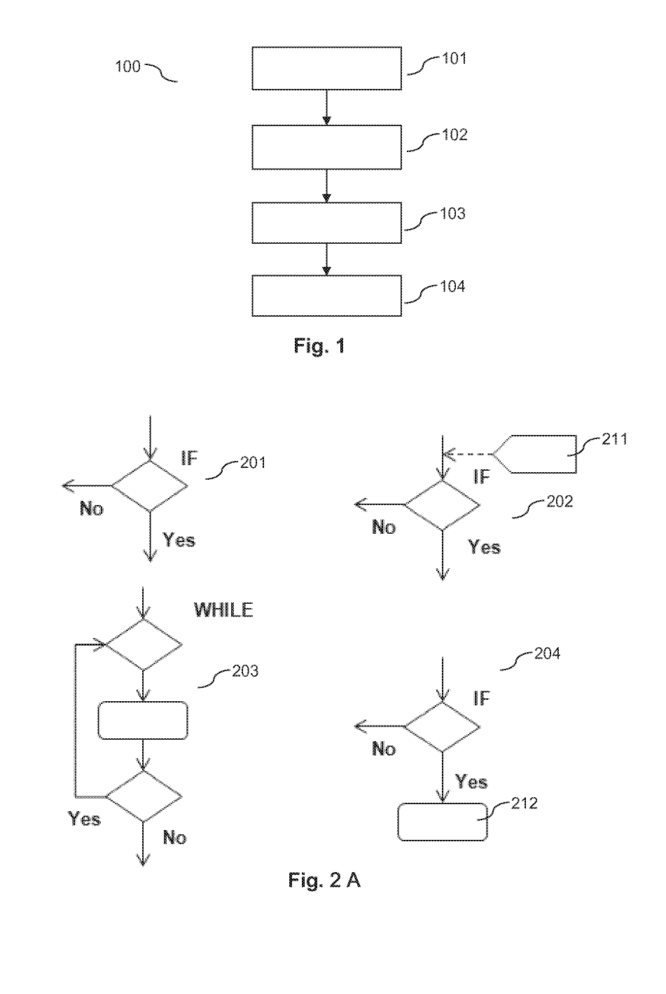

FIG. 1 shows a block diagram of a system for generating code for a technical process of a household appliance;

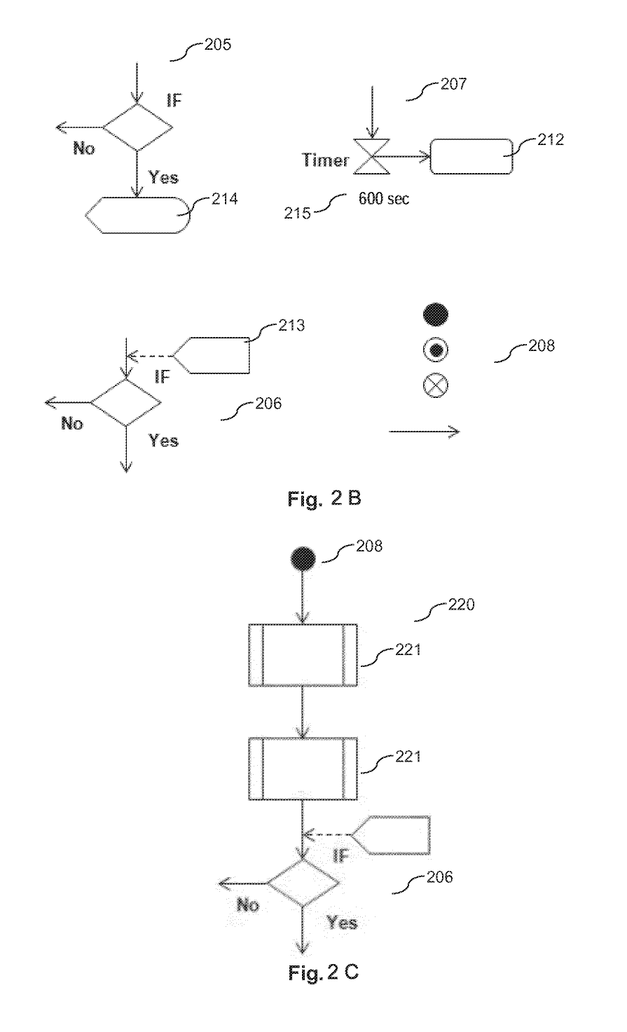

FIGS. 2a to 2c show exemplary graphic elements for describing a technical process;

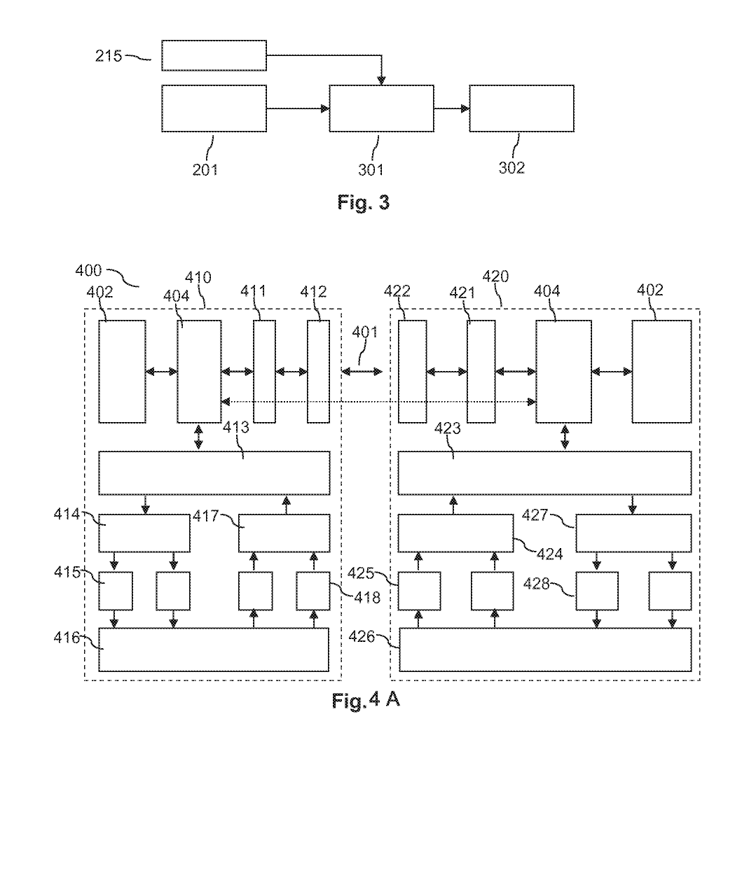

FIG. 3 shows an exemplary conversion of a graphic element into instructions of a metalanguage; and

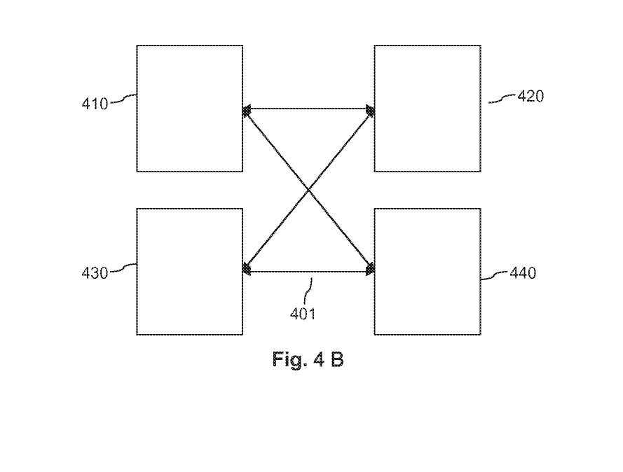

FIGS. 4a and 4b show an exemplary processor system of a household appliance for executing a metalanguage file for a technical process of the household appliance.

As stated in the introduction, the present document relates to the intuitive and efficient generation of software code for different technical processes of different household appliances. In this context, FIG. 1 shows a block diagram of an exemplary system 100 for generating code for a technical process of a household appliance. The system 100 includes a graphic editor 101 that makes it possible to describe a technical process (e.g. a brewing process of an automatic coffee maker and/or a laundry process of a washing machine) using graphic elements. A checking module 102 can be used to check a process that is described on the basis of graphic elements. Here, the checking module 102 may include an expert system that is intended to check the graphically described process for consistency and integrity. In this way, it is possible to ensure that processes described graphically by the graphic editor 101 (that is to say graphical representations of a technical process) are created that may also actually be carried out by a particular household appliance.

The graphic elements of a graphically described process may be converted into a metalanguage file by a translation module 103. In particular, each graphic element may be translated to a sequence of software instruction in a metalanguage such that the graphically described process is converted into a metalanguage file by the translation module 103. The metalanguage file describes the technical process in the metalanguage. Using an interpreter 104 for this metalanguage, it is possible to generate code that can be executed by one or more processors of a household appliance in order to implement the technical process on the household appliance.

FIGS. 2a and 2b show by way of example different graphic elements 201, 202, 203, 204, 205, 206, 207, 208 that may be used to describe graphically a technical process. Here:
the graphic elements 201, 203 describe commands or instructions for a decision loop;
the graphic element 202 describes a command or instruction for access to a measured value of a sensor 211 of a household appliance;
the graphic element 204 describes a command or instruction for controlling an actuator 212 of a household appliance;
the graphic element 205 describes a command or instruction for controlling an output unit 214 (e.g. a screen or LED) of a household appliance;
the graphic element 206 describes a command or instruction for capturing input by a user by way of an input unit 213 (e.g. a key) of a household appliance;
the graphic element 207 describes a command or instruction for establishing a timer or delay (e.g. before control of an actuator 212), wherein a delay value can be established as an exemplary process parameter 215;
the graphic elements 208 describe different commands or instructions, such as a process start, a process end, a sub-process end and calling a process.

As illustrated by way of example in FIG. 2c, the graphic elements 201, 202, 203, 204, 205, 206, 207, 208 may be concatenated in the graphic editor 101 in order to create a graphical representation 220 of a technical process. Here, it is also possible to integrate part processes 221 that have where appropriate themselves been described by graphic elements 201, 202, 203, 204, 205, 206, 207, 208. In this way, technical processes may be graphically described in an efficient manner.

For each graphic element 201, 202, 203, 204, 205, 206, 207, 208, program steps or instructions in a metalanguage may be stored in the system 100, and in particular in the translation module 103. This is illustrated by way of example in FIG. 3. For the graphic element 201, neutral metalanguage program steps or instructions 301 are stored that can be completed by concrete process parameters 215 from the graphically represented technical process in order to determine one or more metalanguage program sections or instructions 302 in the metalanguage. Correspondingly, all the graphic elements 201, 202, 203, 204, 205, 206, 207, 208 of a graphically represented technical process can be converted into metalanguage program sections or instructions 302 in order to generate a metalanguage file for the technical process. This metalanguage file may be converted, by the interpreter, into specific code for one or more processors of a household appliance in order to implement the technical process on the household appliance.

FIG. 4a shows an exemplary implementation of a technical process on two separate modules 410, 420 of a household appliance 400, wherein the modules 410, 420 can exchange data over a data bus 401. Each of the modules 410, 420 includes at least one processor of its own, which is intended to execute software code that is generated on the basis of a metalanguage file 402 for the technical process for the respective processor. The module 410 may be used for example for controlling a user interface, and the module 420 may be used for example for controlling the energy supply to the household appliance 400.

The module 420 includes an interpreter 104, 404 that is intended to interpret the metalanguage file 402 in order to generate code that can be executed by the processor of the module 420. In particular, the code may be executed by a process control manager 423 of the module 420, which may relate to measured values of sensors 425, where appropriate by way of an intermediate layer 424, and/or may transmit instructions to actuators 428, where appropriate by way of an intermediate layer 427. The actual control of the hardware components of the household appliance 400 may be performed by way of a hardware abstraction layer 426. Furthermore, the module 420 has a communication manager 421 and a data bus abstraction layer 422 in order to exchange data over the data bus 401.

Analogously, the module 410 may include an interpreter 404 that is intended to interpret the metalanguage file 402 in order to generate software code that can be executed by the processor of the module 410. In particular, the software code may be executed by a user interface control manager 413 of the module 410, which may relate to input values of one or more input units 418, where appropriate by way of an intermediate layer 417, and/or may transmit output values to one or more output units 415, where appropriate by way of an intermediate layer 414. The actual control of the hardware components of the household appliance 400 may be performed by way of a hardware abstraction layer 416. Furthermore, the module 410 has a communication manager 411 and a data bus abstraction layer 412 in order to exchange data over the data bus 401.

In this way, a technical process metalanguage is used that provides the process engineer of a household appliance 400 with direct access to all the relevant functions of the household appliance 400. The technical process metalanguage is in this case preferably: self-explanatory, and portable quickly and directly to the one or more modules 410, 420 of a household appliance 400; and/or usable in the same form for different types of household appliance 400 (e.g. washing machines, ovens, dishwashers, automatic coffee makers, etc.).

For the purpose of generating metalanguage files 402, an easy-to-use graphic technical process editor 101 is provided that displays complex process structures using graphic elements 201, 202, 203, 204, 205, 206, 207, 208 and may where appropriate be adapted to the requirements of the respective type of household appliance 400.

Furthermore, a unified and simple path may be provided in order to maintain a technical process metalanguage file 402 securely and reliably into the production software of a household appliance 400 or an (online or offline) service support function. Here, in particular the updatability of all control-relevant and user interaction-relevant process parts can be ensured.

Moreover, it is possible to provide a technical process interpreter 104, 404 that spans more than one household appliance and enables rapid integration of a technical process metalanguage file 402 into the software platforms of different types of household appliance 400. Here, the following may in particular be ensured: rapid updatability of the product technical process; a modular structure of the technical process metalanguage file 402 for the purpose of updating individual process parts segment by segment; the enabling of a high level of diversification of the household appliances 400 over different technical processes with an unchanged hardware abstraction layer 416, 426 and control layer 413, 423; and/or rapid access by the technical process to modifications made to a household appliance 400, or minimization of interventions by the embedded software development.

The provision of a technical process metalanguage, the provision of a graphic technical process editor 101, the provision of a unified technical process integration process and/or the provision of a technical process interpreter 104, 404 have numerous advantages: a reduction in technical process integration times; reliable and automatic migration of the technical process into software code for a household appliance 400 (in particular without manual intervention); reduced integration times such that a process engineer can test a new technical process directly on a household appliance 400; reduced test requirements and a simplified testing concept, as a result of the technical process metalanguage; enhanced product security; faster updatability of technical processes; greater diversification of process variants, for example for different countries, with an unchanged hardware abstraction layer and control layer; and/or a modular structure of the technical process metalanguage file 402 for updating individual process parts segment by segment.

In order to convert a graphical description of a technical process (e.g. coffee brewing process, laundry and dishwashing processes, refrigerating processes) into a code for a household appliance 400, typically the human expert knowledge of various experts, for example a process engineer (e.g. in refrigeration engineering), a hardware developer, a software developer, etc. is required. This can result in relatively long development times for new technical processes.

For this reason, the system 100 may take a form such that expert knowledge is taken into account (e.g. in the context of online checking of a graphically represented technical process in the checking module 102 and/or in the context of the interpreter 104, 404). For this purpose, phenomenological artificial intelligence (AI) may be used.

In phenomenological AI, typically only the result of the conversion of the technical process into the logic of an interpreter 104 404 is relevant. No attempt is made to imitate the actual thought processes of the developer on a neural level or simulation level. In a purely result-oriented procedure, it is not the path to the thought that is significant but only the result, with as much depth and as much accuracy of detail as possible. This can be done by collecting the actions of the human model (that is to say of a technical expert) in as many starting situations as possible, generating rules (axioms) based on these, and concatenating these axioms, where appropriate multiple times.

In the context of the AI systems described here, knowledge from different fields can be taken into account: process engineers (experts), suppliers of process components (e.g. a detergent manufacturer, for a laundry process); software developers; module and system testers; and/or users. The AI system may in this case map both the integration level and also the testing and application level for a household appliance 400.

The technical process expert system may in particular be taken into account in the technical process editor 101, which may be implemented on a computer and is intended to convert a simple graphic structure of a process into a complex technical process script (that is to say a metalanguage file 402). Furthermore, the technical process expert system in the technical process interpreter 404 may be taken into account on a module 410, 420 of a household appliance 400, wherein the module 410, 420 is thus executed on the household appliance 400 to be controlled and converts the script (that is to say a metalanguage file 402) into active parallel and sequential operations on the respective module 410, 420.

The AI of the technical process interpreter 404 includes for example an actuator access (with a hardware-specific command set): a description, very simple for a process engineer, of an actuator (e.g. heater(50)—heating to 50 degrees) typically maps a complex control process in the interpreter 404 with the expert knowledge, stored in the AI, of the physics of the actuator (e.g. the functional load capacity). The actuator may be represented by way of an abstract model of many sensor and actuator parameters (e.g. heating of an automatic coffee maker may use as a basis water throughput (flow measurement), timing and frequency parameters of the supply network, and a prediction of the available energy to calculate the temperature of the water in the brewing unit).

The AI of the technical process interpreter 404 includes for example a sensor access (with a hardware-specific command set): a description, very simple for a process engineer, of a sensor (e.g. water flow(50)—flow rate of 50 ml/s) typically maps a complex sensor process in the interpreter 404 with the physics, stored in the AI, of the sensor (e.g. conversion of the directly and indirectly measurable input variables to technical measured variables) (for example, the sensor value for the quantity of ground coffee may be calculated indirectly from the statistically increasing contact pressure of the brewing unit with dry or pre-brewed coffee; a sensor for measuring the quantity of coffee may be stored only as a technical process model in the interpreter 404).

The AI of the technical process interpreter 404 includes for example loops and higher-level and lower-level structures (as a generic command set): typically, process engineers use loops of higher-level and lower-level structures in a different way from software engineers. The AI can take on the delimitation and association of sub-processes and corresponding processes in a form suitable for that comprehended in the technical process.

The AI of the technical process interpreter 404 includes for example IF decisions (as a generic command set): an IF decision in the technical process is typically prompted by the calling actuator, and may trigger a plurality of different actions at the interpreter level. The actuator defines the extended function of the IF decision.

The AI of the technical process interpreter 404 includes for example timing and delays: because one process scheduler is run in the metalanguage interpreter 404 with a plurality of other (parallel) processes, the processing time detected by the interpreter 404 is typically not the same as the actual processor time. Rather, the technical process metalanguage interpreter 404 triggers the maximum times available to the individual modules 410, 420 using the technical process sequence that is known to the interpreter 404, that is to say using the physical constraints on the relevant hardware.

The AI of the technical process interpreter 404 includes for example error handling: the technical process interpreter 404 uses particular solution approaches to decide how an error in the system is handled, whether a current process is interrupted or not, and the level on which error handling is performed.

The AI of the technical process interpreter 404 includes for example redundancy considerations: the technical process interpreter 404 can use available resources to decide how the load is to be distributed over different processors in one household appliance 400 (e.g. for providing failsafety).

The AI of the graphic technical process editor 101 includes, for example:
templates for specific decisions, which allocate different functions and parameter sets to a single symbol in dependence on the concatenated graphic elements 201, 202, 203, 204, 205, 206, 207, 208 (e.g. to an actuator in dependence on an IF decision, loops or timing parameters);
an expert system that uses the concatenation of a plurality of rule-based axioms to check whether a graphic concatenation in the editor 101 is permissible or not given the physical electromechanical features of a household appliance 400; and/or
an expert system that displays a highly complex technical process sequence (e.g. having several thousand concatenated control parameters) in simple graphic meta-structures, making it comprehensible.

The AI of the metalanguage interpreter and the metalanguage editor solves numerous problems in the device control of different types of household appliance 400. In particular, the technical process interpreter and the technical process editor make the ever more complicated control procedures in ever more complex household appliances 400 comprehensible even to non-experts, with the expert system taking on the checking of system limits and hence making the technical process reliable. Furthermore, the interpreter and the editor make it possible for third parties to access technical processes (e.g. providing a “special” washing program for a detergent manufacturer, or a “special” coffee brewing process for a coffee producer). Moreover, the interpreter and the editor make it possible for technical process sequences to be in a form such that an expert system can check them and carry them out. In particular, testing is made simpler and more efficient by the technical process editor. Furthermore, the interpreter and the editor enable a reduction in reject rates of household appliances 400 as a result of an improved plausibility check of the technical processes. Moreover, complex technical processes can be carried out rapidly. As a result of weight balanced performance (that is to say distributed loading of the processors) over different modules 410, 420 of a household appliance 400, enhanced failsafety of the household appliance 400 may be effected. Moreover, greater diversification can be provided.

As already stated above, a household appliance 400 may have a software architecture with a base hardware abstraction layer 416, 426 and a control layer 413, 423 that map as software and control the interaction of all the sensors, actuators, keys, displays and interfaces. Furthermore, the software architecture may have a technical process (in particular a metalanguage file 402) that represents user interactions and program sequences (washing programs, dishwashing programs, coffee brewing programs, etc.) for the household appliance 400.

The software and technical process may be installed, at least partly, on the hardware modules 410, 420 that are available in a household appliance 400. Exemplary modules are: an energy module 420 with process sequence control; a user interface module 410 with control unit, display and keyboard; one or more adapter boards (function modules for controlling sensors and actuators); one or more extension boards (extension modules for projection, light control, input, etc.); and/or network modules for linking networks. The individual modules 410, 420 each have processors that can be used to carry out a distributed technical process, in order to provide an enhanced level of failsafety. The distributed technical process may also be used with low-cost single processor architecture on the modules 410, 420, wherein it is nonetheless possible, over the module boundaries of a plurality of modules 410, 420 that are networked to the data bus 401 of a household appliance 400, to set up redundancies between the individual modules 410, 420.

In particular, the metalanguage interpreter 404 can be used to make the modules 410, 420 of a household appliance 400 multiprocessor-capable. Multiprocessor capability may be produced in that the metalanguage interpreter 404 is encapsulated on each hardware module 410, 420, on the sensor and actuator side by a process control manager 413, 423 and on the data bus side by a communication manager 411, 421 (as illustrated in FIG. 4a). The metalanguage file 402 that is running the respective hardware module 410, 420 does not “see” whether the sensors or actuators are actually coupled to the respective hardware module 410, 420 or are tunneled by way of the data bus 410 to the respective module 410, 420. Consequently, a metalanguage file 402 that is executed on a first module 410 can access hardware components on another module 420 by way of the data bus 401.

For example, a user interface module 410 and an energy module 420 may be used to execute the technical process specified in a metalanguage file 402. Here, each of the two modules 410, 420 can take over a respective part of the control of the technical process (e.g. 10%:90%, 50%:50% or 90%:10%). Weighting of the technical process load is helpful in order to provide a balance between a more powerful and a less powerful processor, and/or to unload a processor in the short to medium term if there is partial failure of the hardware, and/or to make a household appliance 400 extendible, that is to say to make the electronic hardware updatable and upgradable (e.g. for a new display, new features, open architecture, etc.).

Here, the multi-core functionality is not implemented on one module 410, 402, but rather the processors connected to a data bus 410 of a household appliance 400 are used to provide: multiprocessor functionality (dynamic process load distribution between the controllers); redundancy (one controller taking on the processing power of another controller in the event of an error) and/or failsafety (monitoring of the process execution between two or more controllers).

FIG. 4b shows by way of example a household appliance 400 in which four modules 410, 420, 430, 440 are connected to one another by way of a data bus 410. Here, for example two modules 420, 440 may be used to provide two entirely redundant metalanguage process controllers that can both execute the technical process in equivalent manner. Furthermore, a module 410 may be used to provide a failsafe controller (with a metalanguage interpreter 404) that checks that the technical process is executed on the metalanguage process controllers without error and, in the event of an error, intervenes. Moreover, a module 430 may be used to provide a load balance controller (with a metalanguage interpreter 404) that controls the process load and the process execution in a closed-loop control.

A distributed metalanguage interpreter 404 can provide enhanced system stability (in particular multiprocessor functionality). Moreover, a failsafety functionality may be implemented (the system continues to operate even in the event of a hardware failure, where appropriate at reduced power). Furthermore, a distributed metalanguage interpreter 404 enables enhanced error tolerance (a load balance controller detects processor overloads by small program errors and corrects them). Moreover, a distributed metalanguage interpreter 404 enables an enhancement to the extendibility of a household appliance 400. A further advantage of a distributed system is the possibility of reliably updating individual software modules. Because the central process controller is replicated a number of times, it is possible to update an individual component again even if system components are not available because an update has failed.

The present invention is not restricted to the exemplary embodiments shown. In particular, it should be noted that the description and the figures are intended only to illustrate the principle of the proposed systems, method and household appliances.

1-9. (canceled)

10. A system for implementing a technical process on a household appliance, the system comprising:
a graphic editor configured to describe the technical process using graphic elements and to create a graphical representation of the technical process;
a translator unit configured to convert the individual graphic elements of the graphical representation of the technical process into instructions of a metalanguage and to generate a metalanguage file that describes the technical process in the metalanguage, the metalanguage being structured for use of the metalanguage to describe technical processes of a plurality of types of household appliances; and
an interpreter arranged on a hardware module of the household appliance and configured to convert the instructions of the metalanguage file into software code that is specific to the household appliance type, for the purpose of executing the technical process on the household appliance, wherein said interpreter depends on the type of household appliance of the plurality of types of household appliances.

11. The system according to claim 10, further comprising a checking unit configured to check whether the graphical representation of the technical process can be carried out in the household appliance, said checking unit including an expert system based on artificial intelligence.

12. The system according to claim 10, wherein:
the metalanguage includes a plurality of different instructions, and the plurality of different instructions enable one or more of the following:
access to a sensor of the household appliance;
a control of an actuator of the household appliance;
a delay to a process step of the technical process;
a conditional execution of a process step of the technical process;
access to an input unit of the household appliance; and
a control of an output unit of the household appliance.

13. The system according to claim 10, wherein the household appliance of the plurality of types of household appliances is selected from the group consisting of washing machines, tumble dryers, automatic coffee makers, dishwashers, ovens and refrigerators.

14. The system according to claim 10, wherein said interpreter includes an expert system based on artificial intelligence.

15. The system according to claim 10, wherein
the household appliance includes a plurality of hardware modules each having one or more processors; and
said hardware modules each include an interpreter for executing at least some of the instructions of the metalanguage file.

16. A household appliance, comprising:
at least one hardware module including an interpreter configured to convert instructions of a metalanguage file for executing a technical process on the household appliance;
wherein the instructions are derived from a metalanguage that is structured to enable the technical processes of a plurality of types of household appliances to be described using the metalanguage; and
said interpreter being dependent on one type of household appliance of the plurality of types of household appliance.

17. The household appliance according to claim 16, wherein:
said at least one hardware module is one of a plurality of hardware modules each having one or more processors;
each of said hardware modules including an interpreter configured to execute in each case at least some instructions of a metalanguage file; and
the household appliance distributing a carrying out of the instructions of the metalanguage file among said interpreters of said plurality of hardware modules.

18. The household appliance according to claim 17, which comprises a data bus enabling said plurality of hardware modules to exchange data with one another.
